(19) United States
(12) Patent Application Publication
(10) Pub. No.: US 2009/0150955 A1
(43) Pub. Date: Jun. 11, 2009

(54) APPARATUS AND METHOD FOR SWITCH OPERATION OF DOWNSTREAM TERMINAL PLATFORM FOR IP DATA TRANSMISSION USING LEGACY TRANSMISSION SYSTEM IN HFC NETWORK

(76) Inventors: Dong Joon CHOI, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/331,056

(22) Filed: Dec. 9, 2008

(30) Foreign Application Priority Data
Dec. 11, 2007 (KR) 10-2007-0127978

(51) Int. Cl. H04N 7/173

(52) U.S. Cl. 725/111

(57) ABSTRACT

A method and apparatus for a switch operation of a downstream terminal platform for Internet Protocol (IP) data transmission using a legacy transmission system in a Hybrid Fiber Coax (HFC) network is provided. The downstream terminal platform includes: a Radio Frequency (RF) transmitter to distribute and combine a signal transceived by an HFC network; a broadband downstream receiver to process a broadband signal received by the RF transmitter; a cable modem (CM) to process data received or transmitted by the RF transmitter; an IP layer switch to transmit data to a corresponding Customer Premises Equipment (CPE), the data being received from the broadband downstream receiver to the CPE, or to enable user data received from the CPE to be transmitted to a headend using the CM; and a subscriber controller to control the downstream terminal platform.

### CROSS-REFERENCE TO RELATED APPLICATION

This application claims priority from Korean Patent Application No. 10-2007-0127978, filed on Dec. 11, 2007, in the Korean Intellectual Property Office, the entire disclosure of which is incorporated herein by reference.

### BACKGROUND OF THE INVENTION

1. Field of the Invention

The present invention relates to a method and apparatus for a switch operation of a downstream terminal platform for Internet Protocol (IP) data transmission using a broadband downstream cable transceiving system and a legacy transmission system in a Hybrid Fiber Coax (HFC) network, and more particularly, to a method and apparatus for a switch operation needed to be performed by a terminal platform when intending to perform IP-based data transmission using a newly-developed broadband downstream cable modem and a legacy widely-used data transmission system.

This work was supported by the IT R&D program of MIC/IITA [2006-S-019-02, The Development of Digital Cable Transmission and Receive System for 1 Gbps Downstream].

2. Description of Related Art

A system being a subject of development in a cable transceiving system, which is currently being developed with new schemes, gives priority to downstream transmission. This results from a fact that many applications require broadband downstream transmission in a cable network. However, when actually intending to provide a service, two-way data transmission is necessary, however much time and effort are necessary for developing an upstream transmission system using a new standard. Accordingly, in order to smoothly provide the service using a newly-developed broadband downstream cable transceiving system, it may be an alternative proposal that an upstream transmission portion uses a cable modem (CM) and a Cable Modem Termination System (CMTS) transmitting data in a legacy cable network and following a standard such as Data Over Cable Service Interface Specifications (DOCSIS) 1.0. 1.1, 2.0, and the like, and high-speed downstream data transmission uses a downstream 1 Gbps cable transceiving system being developed.

A requisite for embodying a two-way Internet Protocol (IP) data transmission network using both a new broadband downstream cable transceiving system and a legacy transmission system is that a headend transmission system and a terminal platform need to include an IP switch function. Downstream data is transmitted to a new broadband downstream transmission system in a headend IP switch block, and the data received from a Customer Premises Equipment (CPE) is transmitted to a headend in an IP switch block of the terminal platform using a legacy DOCSIS 2.x transmission network. In the case of the headend, using a separate commercial IP switch is easy for an IP switch function. However, when using the separate commercial switch for the IP switch function in the case of the terminal platform, a functional restriction exists in transmitting upstream data using a legacy network, and a problem in a physical size and an embodiment cost of the terminal platform occurs. Therefore, an IP switch method and apparatus that may be easily embodied in the terminal platform when intending to effectively perform two-way data transmission using a newly-developed broadband downstream transmission system and a legacy DOCSIS 2.x-based data transmission system is disclosed.

### SUMMARY OF THE INVENTION

An aspect of the present invention provides a method and apparatus for a switch operation of a downstream terminal platform for Internet Protocol (IP) data transmission using a legacy transmission system in a Hybrid Fiber Coax (HFC) network.

Another aspect of the present invention also provides an IP switch method and apparatus of a downstream terminal platform which enables two-way data transmission using a broadband downstream transmission system and a legacy Data Over Cable Service Interface Specifications (DOCSIS) 2.x-based data transmission system.

The present invention is not limited to the above-described purposes and other purposes not described herein will be apparent to those of skill in the art from the following description.

According to an aspect of the present invention, there is provided a downstream terminal platform of a two-way transmission apparatus, the downstream terminal platform including: a Radio Frequency (RF) transmitter to distribute and combine a signal transceived by an HFC network; a broadband downstream receiver to process a broadband signal received by the RF transmitter; a cable modem (CM) to process data received or transmitted by the RF transmitter; an IP layer switch to transmit data to a corresponding Customer Premises Equipment (CPE), the data being received from the broadband downstream receiver to the CPE, or to enable user data received from the CPE to be transmitted to a headend using the CM; and a subscriber controller to control the downstream terminal platform.

According to another aspect of the present invention, there is provided a switching method of a downstream terminal platform for IP data transmission using a broadband downstream cable transceiving system and a legacy transmission system, the method including: receiving a packet; verifying an input port in which the received packet is inputted; and switching to output the received packet to a corresponding CPE when the received packet corresponds to data received from a broadband downstream receiver to the CPE based on a verification result of the input port, and switching to output the received packet to a CM when the received packet corresponds to user data received from the CPE.

Additional aspects, features, and/or advantages of the invention will be set forth in part in the description which follows and, in part, will be apparent from the description, or may be learned by practice of the invention.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates an overview of a two-way data transmission apparatus using a broadband downstream transmission system and a Data Over Cable Service Interface Specifications (DOCSIS) 2.x-based data transmission system according to an exemplary embodiment of the present invention;

FIG. 2 illustrates a configuration of a headend in a two-way data transmission apparatus according to an exemplary embodiment of the present invention;

FIG. 3 illustrates a configuration of a terminal platform in a two-way data transmission apparatus according to an exemplary embodiment of the present invention;

FIG. 4 illustrates a subnet configuration used in a two-way data transmission apparatus according to an exemplary embodiment of the present invention:

FIG. 5 is a block diagram illustrating a structure of an Internet Protocol (IP) layer switch of a terminal platform for two-way data transmission according to an exemplary embodiment of the present invention; and

FIG. 6 is a flowchart illustrating a process of switching in an IP layer switch of a terminal platform for two-way data transmission according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures. When detailed descriptions related to a well-known related function or configuration are determined to make the spirits of the present invention ambiguous, the detailed descriptions will be omitted herein.

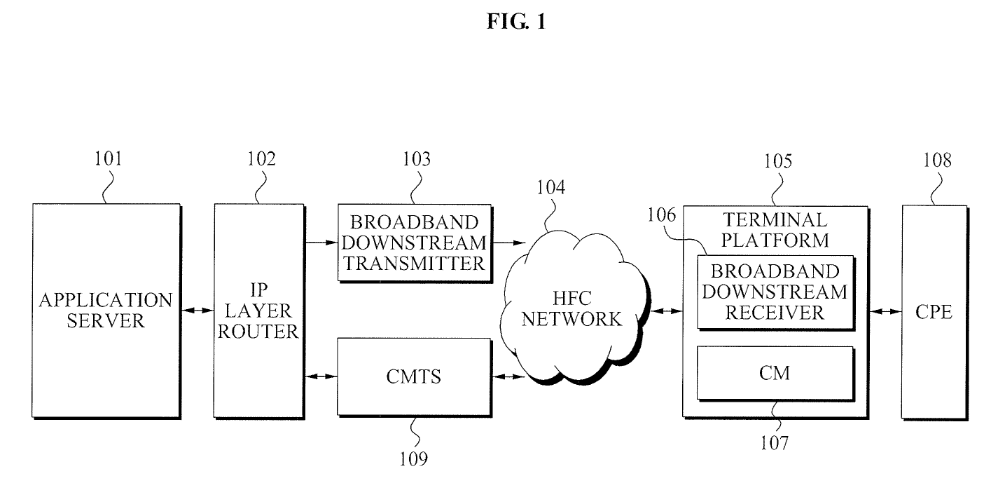

The present invention relates to an Internet Protocol (IP) switch method and apparatus of a downstream terminal platform to enable two-way data transmission using a broadband downstream transmission system and a legacy Data Over Cable Service Interface Specifications (DOCSIS) 2.x-based data transmission system, and an overview of an exemplary embodiment of the present invention is described below with reference to FIG. 1.

FIG. 1 illustrates an overview of a two-way data transmission apparatus using a broadband downstream transmission system and a DOCSIS 2.x-based data transmission system according to an exemplary embodiment of the present invention.

Referring to FIG. 1, a broadband downstream transmitter 103 and a broadband downstream receiver 106 in the two-way data transmission apparatus in a Hybrid Fiber Coax (HFC) network 104 according to an exemplary embodiment of the present invention correspond to a broadband downstream transceiving system supporting a new downstream physical layer or using channel bonding, and exclude upstream channel transmission. Accordingly, a legacy DOCSIS-based Cable Modem Termination System (CMTS) 109 and a cable modem (CM) 107 are included for two-way transmission between a headend and a Customer Premises Equipment (CPE) 108. Here, upstream band transmission is provided. Specifically, when transmitting data from an application server 101 in either an external network or the headend, the CMTS 109 existing in the headend and supporting a scheme conforming to legacy DOCSIS 2.0 or earlier versions transmits general user data by a broadband using the broadband downstream transmitter 103 and the broadband downstream receiver 106 corresponding to a new transmission system, and transmits a management message between the CM 107 and the CMTS 109 other than the user data using the CM 107 and the CMTS 109 corresponding to a legacy transmission system. Whether the user data is transmitted from the headend to either the broadband or a legacy service band is determined by an IP layer router 102. The IP layer router 102 performs routing to enable all downstream user data to use the broadband downstream transmitter 103. As described above, when separating the user data from management message data and respectively transmitting the user data and the management message data, a transmitted data amount of the management data is smaller than a transmitted data amount of the user data, and the management message may be efficiently processed by transmitting all management messages between the CM 107 and the CMTS 109 using a single physical layer. A user having a legacy CM not supporting the above-described transmission scheme may be provided with a new service in a transmission capability range of a legacy service and a legacy physical layer using, the legacy physical layer and a legacy channel.

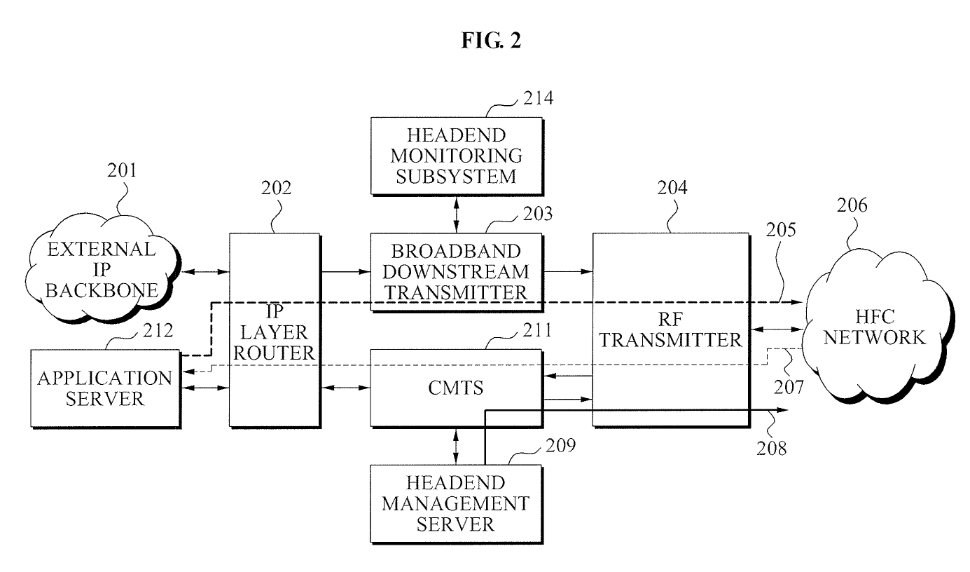

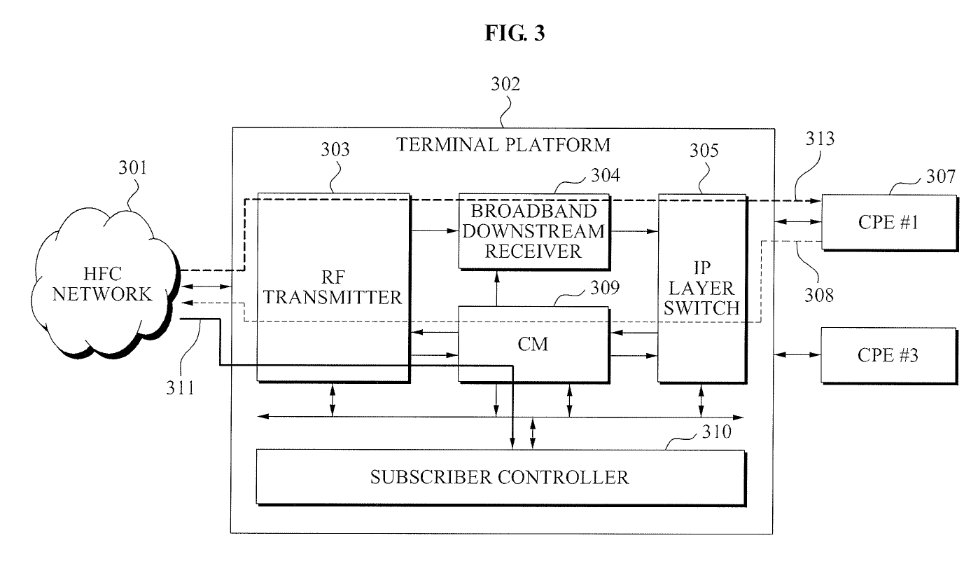

The headend and a terminal platform 105 in the two-way data transmission apparatus of FIG. 1 are described in detail below with reference to FIG. 2 and FIG. 3.

FIG. 2 illustrates a configuration of a headend in a two-way data transmission apparatus according to an exemplary embodiment of the present invention. The headend in an HFC network 206 according to an exemplary embodiment of the present invention generally includes an IP layer router 202, a broadband downstream transmitter 203, a DOCSIS-based CMTS 211, a headend management server 209, a headend monitoring subsystem 214, and a Radio Frequency (RF) transmitter 204.

Data 205 transmitted from an application server 212 in an external network such as an external IP backbone 201 or the headend in an IP form is transmitted to the new broadband downstream transmitter 203 using the IP layer router 202, and a broadband transmission system of the headend and a terminal receiving apparatus logically include a single IP subnet. The legacy DOCSIS-based CMTS 211 transmits information about a service being provided by the headend management server 209 and data 208 for overall network management using a downstream band of 6 MHz, receives request and management data from a terminal platform using an upstream band, and transmits the request and management data to be processed by the headend management server 209. Upstream data 207 transmitted from a CM is transmitted to the application server 212 using the CMTS 211.

FIG. 3 illustrates a configuration of a terminal platform 302 in a two-way data transmission apparatus according to an exemplary embodiment of the present invention.

The terminal platform 302 in an HFC network 301 generally includes an IP layer switch 305, a broadband downstream receiver 304, a DOCSIS-based CM 309, a subscriber controller 310, and an RF transmitter 303.

Referring to FIG. 3, the IP layer switch 305 in the terminal platform 302 according to an exemplary embodiment of the present invention transmits downstream data 313 received from the broadband downstream receiver 304 to a CPE 307 being a corresponding IP-based subscriber apparatus, and transmits upstream user data 308 transmitted from the CPE 307 to a headend using the CM 309. Configuration information data related to the terminal platform 302 is transceived by the subscriber controller 310, and data related thereto is transmitted to the subscriber controller 310, and the data is transmitted from the subscriber controller 310 using the CM 309.

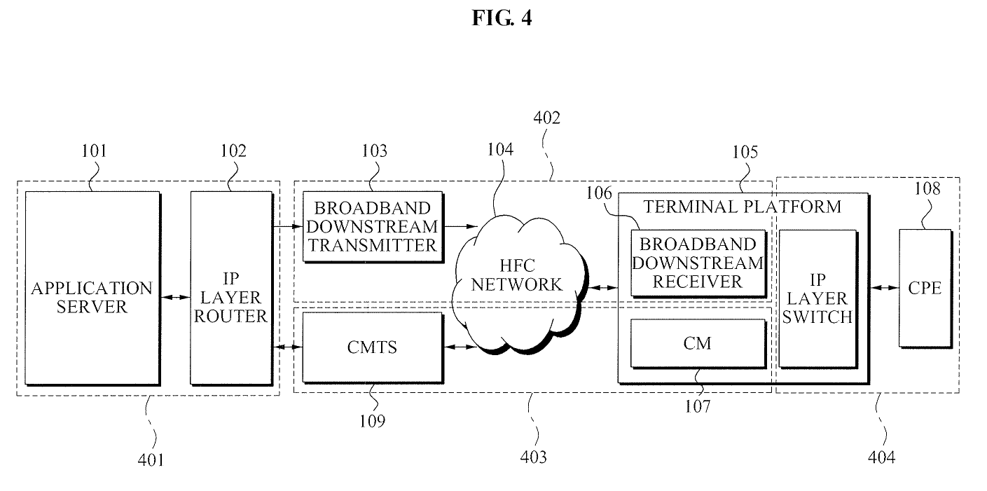

FIG. 4 illustrates a subnet configuration used in a two-way data transmission apparatus according to an exemplary embodiment of the present invention. Referring to FIG. 4, the two-way data transmission apparatus according to an exemplary embodiment of the present invention respectively includes transmission networks 402 and 403 being each subnet in a broadband transceiving and DOCSIS-based transmission scheme. Data is set to be transmitted from an external network 401 to a broadband transceiving system using an IP router in a headend, and an IP switch in a terminal platform is set to transmit the data to a network 404 in which a CPE received from a terminal exists. An IP switching module of a subscriber apparatus needs to be set so that the data from the network 404 in which the CPE exists may be transmitted using the DOCSIS-based upstream transmission network 403. A DOCSIS-based CMTS in the headend needs to include a separate subnet between the IP router and the CMTS when a router is built-in, and may operate as a subnet configuration using a legacy DOCSIS-based transmission system between a headend IP router and a terminal apparatus eliminating a need for including the separate subnet when operating as a bridge mode.

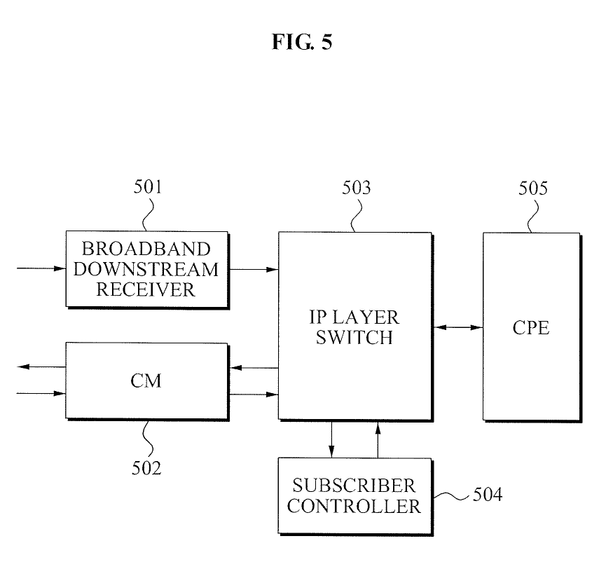

FIG. 5 is a block diagram illustrating a structure of an IP layer switch of a terminal platform for two-way data transmission according to an exemplary embodiment of the present invention. Referring to FIG. 5, subscriber controllers 310 and 504 according to an exemplary embodiment of the present invention perform functions including initialization with respect to each module operation in the terminal platform 302, configuration information setting, collection of error/management data during operation, and the like. IP layer switches 305 and 503 generally include four ports. An output from each port is not transmitted to all ports, and a port to be outputted and a function are different depending on input ports. An output port with respect to an input of each port and the function are illustrated in Table 1.

TABLE 1

| Input port | Output port | Functions of IP layer switches 305 and 503 |
|---|---|---|
| Broadband | CPE 505 | Set a destination Media Access Control (MAC) address |
| downstream | | of a corresponding packet as a MAC address of the CPE |
| receiver | | and output the packet to CPE when an IP address of the |
| 501 | | CPE is retrieved |
| | Subscriber | Output the corresponding packet to a terminal platform |
| | controller 504 | controller when the IP address of the subscriber |
| | | controller is retrieved |
| CPE 505 | CM 502 | Acquire a MAC/IP address of the CPE using snooping in |
| | | the case of a Dynamic Host Configuration Protocol |
| | | (DHCP) message |
| CM 502 | CPE 505 | Output the packet to the CPE using the MAC/IP address |
| | | acquired by CPE DHCP message snooping when the IP |
| | | address of the CPE is retrieved |
| | Subscriber | Output the corresponding packet to the terminal platform |
| | controller 504 | controller when the MAC address of the terminal |
| | | platform controller is retrieved |
| Subscriber | CM 502 | Transmit the packet to the CM 502 without special |
| controller | | processing |
| 504 | | |

A message flow in FIG. 2 is described in detail below with reference to FIG. 5. First, DHCP message snooping is described. When an initialization process among the commercial CMTS 211 and the CMs 309 and 502 is completed, the CPEs 307 and 505 transmit a DHCP request message to a path of “CPEs 307 and 505→IP layer switches 305 and 503→CMs 309 and 502→CMTS 211→headend management server 209”, and a DHCP response message passes through a path of “headend management server 209→CMTS 211→CMs 309 and 502→IP layer switches 305 and 503→CPEs 307 and 505”. The IP layer switches 305 and 503 need to acquire a MAC and an IP of the CPEs 307 and 505 using DHCP snooping, and need to be set the MAC and the IP in an internal register.

IP allocation and management message processing of the subscriber controllers 310 and 504 are subsequently described. When the IP is required for transceiving a management message, the subscriber controllers 310 and 504 transmits the DHCP request message to a path of “subscriber controllers 310 and 504→IP layer switches 305 and 503→CMs 309 and 502→CMTS 211→a DHCP server such as the headend management server 209”, and receives the DHCP response message through a path of “headend management server 209→CMTS 211→CMs 309 and 502→IP layer switches 305 and 503→terminal platform controllers such as the subscriber controllers 310 and 504”. The subscriber controllers 310 and 504 set an address of the headend monitoring subsystem 214 to communicate with and the MAC address of the CMTS 211 using information set in an option of the DHCP response message. Here, the MAC address of the CMTS 211 may be acquired in the subscriber controllers 310 and 504 using an Address Resolution Protocol (ARP). When the MAC address of the CMTS 211 does not exist in the DHCP response message, the subscriber controllers 310 and 504 transmit an ARP request message for acquiring the MAC address of the CMTS 211 to a path of “subscriber controllers 310 and 504→IP layer switches 305 and 503→CMs 309 and 502→CMTS 211”, and receive an ARP reply message through a path of “CMTS 211→CMs 309 and 502→IP layer switches 305 and 503→subscriber controllers 310 and 504”. The IP layer switches 305 and 503 search for the MAC address and, when the address corresponds to the subscriber controllers 310 and 504, the IP layer switches 305 and 503 transmit the message to the subscriber controllers 310 and 504. As described above, when the IP is allocated to the subscriber controllers 310 and 504, the management message may be transmitted from the terminal platform 302 to the broadband downstream transmitter 203. The management message may be transmitted by generating IP traffic in a terminal platform central processing unit (CPU). In this instance, a path corresponds to “subscriber controllers 310 and 504→IP layer switches 305 and 503→CMs 309 and 502→CMTS 211→router 202→headend monitoring subsystem 214→broadband downstream transmitter 203”. The subscriber controllers 310 and 504 generally transmit the data for management to only an IP address of a CM monitoring system such as the headend monitoring subsystem 214. In this instance, the destination MAC address corresponds to the address of the CMTS 211. Control message communication between the broadband downstream transmitter 203 and the terminal platform 302 is possible using Remote Procedure Call (RPC) communication between the headend monitoring subsystem 214 and the broadband downstream transmitter 203. A message required for an operation may be defined by a need of a user and may be used.

Downstream packet processing is subsequently described. Since a MAC address of a user packet transmitted from the broadband downstream transmitter 203 corresponds to the MAC address set when the broadband downstream transmitter 203 terminates the ARP, whether forwarding to the CPEs 307 and 505, forwarding to the CPU, or deletion is performed is determined using an IP search. A MAC management message such as UCD, MDD, and MAP is set as a multicast MAC address defined in DOCSIS and is transmitted. When traffic is transmitted using the broadband downstream transmitter 203 (*broadband downstream receiver 304?), a path corresponds to “an external network such as the external IP backbone 201→router 202→broadband downstream transmitter 203→broadband downstream receivers 304 and 501→IP layer switches 305 and 503→either the CPEs 307 and 505 or the subscriber controllers 310 and 504”. The IP layer switches 305 and 503 search for the IP address of all downstream traffic and when the IP address corresponds to the IP address allocated to the CPEs 307 and 505, the IP layer switches 305 and 503 substitute information about a destination MAC address area existing in the corresponding packet with the MAC address of the CPEs 307 and 505. When the IP address corresponds to the IP address of the terminal platform controllers such as the subscriber controllers 310 and 504, the corresponding packet is transmitted to the subscriber controllers 310 and 504.

ARP message processing in the broadband downstream transmitter 203 is subsequently described. An ARP message from the router 202 located in front of the broadband downstream transmitter 203 needs to be terminated. When an ARP request message is inputted from the router 202, the broadband downstream transmitter 203 sets an IP address of an ARP reply message and the MAC address as a value set by an operator in advance, transmits the IP address and the MAC address to the router 202, and terminates the ARP message.

Address setting of the headend management server 209 is finally described. The headend management server 209 needs to identify a MAC address of a client in the DHCP request message, and needs to transmit different response message depending on the subscriber controllers 310 and 504, the CMs 309 and 502, the CPEs 307 and 505, and the like. Setting such as setting defined in general DOCSIS is required for the CMs 309 and 502 and the CPEs 307 and 505, and the IP address of the headend monitoring subsystem 214 and the MAC address of the CMTS 211 to transceive the management message to/from the subscriber controllers 310 and 504 need to be reported in the case of the DHCP request message requested by the subscriber controllers 310 and 504. This is performed using a user definition in a DHCP option field. When the IP address is reported instead of the MAC address of the CMTS 211 being a default router, the subscriber controllers 310 and 504 acquire the MAC address of the CMTS 211 using an ARP process.

Hereinafter, a method for a switch operation of a downstream terminal platform for two-way IP data transmission using a legacy transmission system in an HFC network according to an exemplary embodiment of the present invention is described with reference to the drawing.

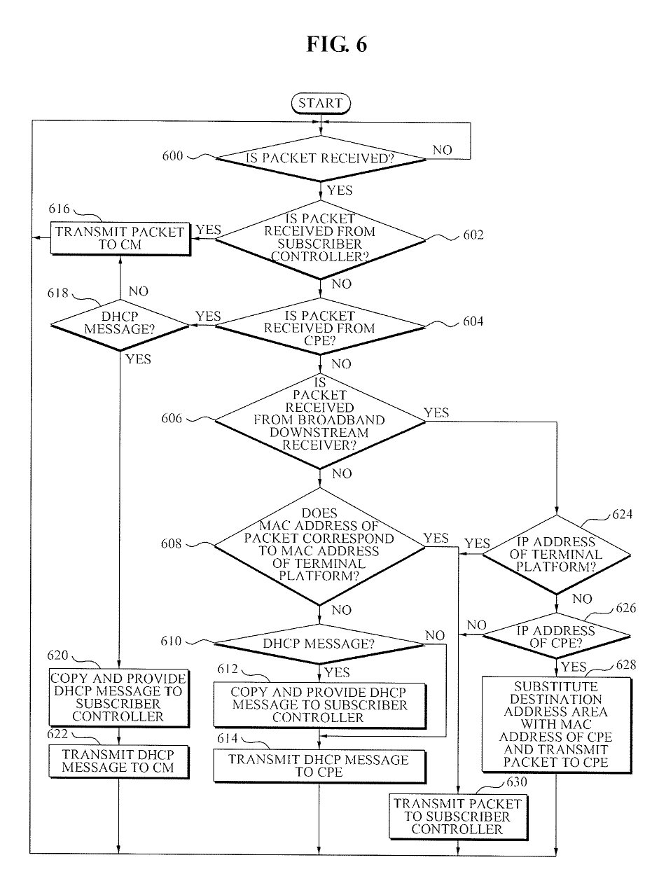

FIG. 6 is a flowchart illustrating a process of switching in an IP layer switch of a terminal platform for two-way data transmission according to an exemplary embodiment of the present invention. Referring to FIG. 6, when a packet is received in operation 600, the IP layer switch 503 according to an exemplary embodiment of the present invention performs following operation based on an input port of the received packet.

When it is verified that the packet is received from the subscriber controller 504 in operation 602, the IP layer switch 503 proceeds to operation 616, transmits the received packet to the DOCSIS-based CM 502, returns to operation 600, and repeats a consecutive process according to an exemplary embodiment of the present invention.

When it is verified that the packet is received from the CPE 505 in operation 604, the IP layer switch 503 proceeds to operation 618 and verifies whether the received packet corresponds to a DHCP message. When it is verified that the received packet is different from the DHCP message, the IP layer switch 503 proceeds to operation 616 and outputs the received packet to the DOCSIS-based CM 502. However, when it is verified that the received packet corresponds to the DHCP message in operation 618, the IP layer switch 503 proceeds to operation 620, copies and provides the DHCP message to the subscriber controller 504, proceeds to operation 622, and transmits the DHCP message to the DOCSIS-based CM 502.

When it is verified that the packet is received from the broadband downstream receiver 501 in operation 606, the IP layer switch 503 proceeds to operation 624 and verifies whether an IP address of the received packet corresponds to the IP address of the terminal platform. When it is verified that the IP address of the received packet is different from the IP address of the terminal platform, the IP layer switch 503 proceeds to operation 626 and verifies whether the IP address of the received packet corresponds to the IP address of the CPE. When it is verified that the IP address of the received packet corresponds to the IP address of the CPE, the IP layer switch 503 proceeds to operation 628, substitutes a destination address area of the received packet with a MAC address of the CPE, transmits the packet to the CPE, returns to operation 600, and repeats a consecutive process according to an exemplary embodiment of the present invention.

When it is verified that the IP address of the received packet corresponds to the IP address of the terminal platform in operation 604 or when it is verified that the IP address of the received packet is different from the IP address of the CPE in operation 626, the IP layer switch 503 proceeds to operation 630, transmits the received packet to the subscriber controller 504, returns to operation 600, and repeats a consecutive process according to an exemplary embodiment of the present invention.

When it is verified that the packet is not received from the broadband downstream receiver 501 and is received from the CM 502 in operation 606, the IP layer switch 503 proceeds to operation 608 and verifies whether a MAC address of the packet corresponds to the MAC address of the terminal platform. When it is verified that the MAC address of the packet corresponds to the MAC address of the terminal platform, the IP layer switch 503 proceeds to operation 630, transmits the received packet to the subscriber controller 504, returns to operation 600, and repeats a consecutive process according to an exemplary embodiment of the present invention.

When it is verified that the MAC address of the packet is different from the MAC address of the terminal platform in operation 608, the IP layer switch 503 proceeds to operation 610 and verifies whether the received packet corresponds to the DHCP message. When it is verified that the received packet is different from the DHCP message, the IP layer switch 503 proceeds to operation 614, transmits the received packet to the CPE 505, returns to operation 600, and repeats a consecutive process according to an exemplary embodiment of the present invention.

When it is verified that the received packet corresponds to the DHCP message in operation 610, the IP layer switch 503 proceeds to operation 612, copies and provides the DHCP message to the subscriber controller 504, proceeds to operation 614, transmits the DHCP message to the CPE 505, returns to operation 600, and repeats a consecutive process according to an exemplary embodiment of the present invention.

As described above, according to the present invention, there may be provided a method and apparatus of a switch operation of a downstream terminal platform for IP data transmission using a legacy transmission system in an HFC network which can include a switch to perform only a necessary operation and reduce a size of the downstream terminal platform and a production unit cost. Here, the downstream terminal platform includes: an RF transmitter to distribute and combine a signal transceived by an HFC network; a broadband downstream receiver to process a broadband signal received by the RF transmitter; a CM to process data received or transmitted by the RF transmitter; an IP layer switch to transmit data to a corresponding CPE, the data being received from the broadband downstream receiver to the CPE, or to enable user data received from the CPE to be transmitted to a headend using the CM; and a subscriber controller to control the downstream terminal platform.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A downstream terminal platform of a two-way transmission apparatus the downstream terminal platform comprising:
a Radio Frequency (RF) transmitter to distribute and combine a signal transceived by a Hybrid Fiber Coax (HFC) network;
a broadband downstream receiver to process a broadband signal received by the RF transmitter;
a cable modem (CM) to process data received or transmitted by the RF transmitter;
an Internet Protocol (IP) layer switch to transmit data to a corresponding Customer Premises Equipment (CPE), the data being received from the broadband downstream receiver to the CPE, or to enable user data received from the CPE to be transmitted to a headend using the CM; and
a subscriber controller to control the downstream terminal platform.

2. The downstream terminal platform of claim 1, wherein, when a packet is received from the subscriber controller, the IP layer switch transmits the received packet to the CM.

3. The downstream terminal platform of claim 1, wherein, when a Dynamic Host Configuration Protocol (DHCP) message is received from the CPE, the IP layer switch copies and provides the DHCP message to the subscriber controller, and transmits the DHCP message to the CM.

4. The downstream terminal platform of claim 3, wherein, when a packet other than the DHCP message is received from the CPE, the IP layer switch transmits the received packet to the CM.

5. The downstream terminal platform of claim 1, wherein, when a packet including an IP address of the downstream terminal platform is received from the broadband downstream receiver, the IP layer switch transmits the packet to the subscriber controller.

6. The downstream terminal platform of claim 1, wherein, when a packet including an IP address of the CPE is received from the broadband downstream receiver, the IP layer switch substitutes a destination address of the packet with a Media Access Control (MAC) address of the CPE, and transmits the packet to the CPE.

7. The downstream terminal platform of claim 1, wherein, when a packet including a MAC address of the downstream terminal platform is received from the CM, the IP layer switch transmits the packet to the subscriber controller.

8. The downstream terminal platform of claim 1, wherein, when a DHCP message is received from the CM, the IP layer switch copies and provides the DHCP message to the subscriber controller, and transmits the DHCP message to the CPE.

9. The downstream terminal platform of claim 8, wherein, when a packet other than the DHCP message is received from the CPE, the IP layer switch verifies whether a MAC address of the received packet corresponds to a MAC address of the downstream terminal platform, and transmits the received packet to the CPE when the MAC address of the received packet is different from the MAC address of the downstream terminal platform.

10. A switching method of a downstream terminal platform for IP data transmission using a broadband downstream cable transceiving system and a legacy transmission system, the method comprising:
receiving a packet;
verifying an input port in which the received packet is inputted; and
switching to output the received packet to a corresponding CPE when the received packet corresponds to data received from a broadband downstream receiver to the CPE based on a verification result of the input port, and switching to output the received packet to a CM when the received packet corresponds to user data received from the CPE.

11. The method of claim 10, wherein, when an input is determined to correspond to an input from a subscriber controller based on the verification result of the input port, the switching switches to output the received packet to the CM.

12. The method of claim 10, wherein, when an input is determined to correspond to an input from the CPE based on the verification result of the input port and the received packet corresponds to a DHCP message, the switching copies and outputs the DHCP message to a subscriber controller, and switches to output the received packet to the CM.

13. The method of claim 10, wherein, when an input is determined to correspond to an input from the CPE based on the verification result of the input port and the received packet is different from a DHCP message, the switching switches to output the received packet to the CM.

14. The method of claim 10, wherein, when an input is determined to correspond to an input from the broadband downstream receiver based on the verification result of the input port and the received packet includes an IP address of the downstream terminal platform, the switching switches to output the packet to a subscriber controller.

15. The method of claim 10, wherein, when an input is determined to correspond to an input from the broadband downstream receiver based on the verification result of the input port and the received packet includes an IP address of the CPE, the switching switches to substitute a destination address of the packet with a MAC address of the CPE and to output the packet to the CPE.

16. The method of claim 10, wherein, when an input is determined to correspond to an input from the CM based on the verification result of the input port and the received packet includes a MAC address of the downstream terminal platform, the switching switches to output the packet to a subscriber controller.

17. The method of claim 10, wherein when an input is determined to correspond to an input from the CM based on the verification result of the input port and the received packet corresponds to a DHCP message, the switching copies and outputs the DHCP message to a subscriber controller, and switches to output the received packet to the CPE.

18. The method of claim 10, wherein, when an input is determined to correspond to an input from the CPE based on the verification result of the input port and the received packet is different from a DHCP message, the switching verifies whether a MAC address of the received packet corresponds to a MAC address of the downstream terminal platform, and switches to output the received packet to the CPE when the MAC address of the received packet is different from the MAC address of the downstream terminal platform.
